(19) United States
(12) Patent Application Publication
(10) Pub. No.: US 2002/0013766 A1
(43) Pub. Date: Jan. 31, 2002

(54) Commercial settlement system with prepaid type credit card

(75) Inventor: Chiharu Kumaki, Bunsui-machi (JP)

Correspondence Address: SUGHRUE, MION, ZINN MACPEAK & SEAS, PLLC, 2100 Pennsylvania Avenue, N.W., Washington, DC, 20037, US

(73) Assignee: CHIHARU KUMAKI

(21) Appl. No.: 09/886,261

(22) Filed: Jun. 22, 2001

(30) Foreign Application Priority Data
Jul. 25, 2000 (JP) 2000-224232
Apr. 26, 2001 (JP) 2001-129108

(51) Int. Cl. G06F 17/60

(52) U.S. Cl. 705/39

(57) ABSTRACT

To provide a commercial settlement system using a novel prepaid credit card that may easily be owned by any one, may be used extensively for transactions like a credit card, may suppress a criminal risk and damage, the commercial transaction settlement system using a prepaid credit card is characterized by being composed of a financial agency for providing an accounting bankbook, issuing at least one prepaid credit card for which a usable maximum amount is set within an accounting amount of the accounting bankbook or a sum of the usable maximum amounts is set within the accounting amount, automatically paying from the bankbook and settling the commercial transaction in the same manner as a credit card by the transaction using the prepaid credit card, and displaying the settlement record of the commercial transaction on the bankbook, and a goods/service provider for being paid from the bankbook of a holder of the prepaid credit card to thereby settle the commercial transaction using the prepaid credit card.

### BACKGROUND OF THE INVENTION

The present invention relates to a commercial settlement system with a prepaid credit card.

Currently, a variety of cards have been used for commercial transaction. It is possible to point out as main cards a credit card, a debit card, a prepaid card, a card with an accounting settlement function of a foreign country (United Kingdom) and the like.

Among these, the most currently available card is a credit card. This is a very convenient card that may be used not only for the commercial transaction in a variety of domestic or foreign retail shops and but also for internet shopping or mail-order business.

However, this credit card suffers from the following defects:

i) It is necessary to conduct an entrance examination for issuing a card. Any one may not be allowed to have the card. Accordingly, there are many people who could not have the card even though they desire to have.

ii) Since the payment settlement of an account for the used money will be done later and persons who has no sufficient money may conduct the commercial transaction, persons are likely to use too much to go into bankruptcy.

iii) Such tendency has been going up that a copied card is made when the credit card is used in a retail shop or a card number is stolen when the card is used through the internet to suffer from criminal violation. Furthermore, if any notification has not been submitted unconsciously when the card is missed or stolen, the person might have an unexpected damage.

Also, since the debit card is a cash card of a bankbook of a monetary organization, the debit card may be soon issued to any one in comparison with the credit card and he or she may use the money only within the accounting sum available on the bankbook. Thus, the debit card has an advantage to avoid the too much payment to settle the transaction. However, the debit card has defects such that the debit card is limited to the available retail shops and could not be used for mail-order business or e-commerce. Also, the debit card has another defect that, since the usable limit amount changes in accordance with payment or expense to the bankbook, in the case where the deposit amount is very large, the commercial transaction may be conducted freely without any limit corresponding to the deposit amount so that the money would be too much expended.

Also, the prepaid card such as a telephone card or a highway card has an advantage that any one may buy it as desired but has a disadvantage that the service is limited to a specific one.

Also, a card with an accounting settlement function of a foreign country has an advantage that it may be used for commercial transaction in various field in the same manner as the credit card and although it is not of the simultaneous settlement, there is no fear that the settlement would be impossible after the money is too much expended since the payment is only possible within the saving amount as in the debit card. However, the card has the following disadvantages:

i) A procedure to issue the card is very troublesome.

ii) A service charge is expensive in comparison with domestic remittance because the payment is remitted to a foreign country and also, it takes one day or more to remit to the bank unlike the remittance to the domestic bank.

iii) There is no bankbook and the transaction statement is fed rather later. This is inconvenient for the person who knows soon the content of transaction.

### SUMMARY OF THE INVENTION

In view of the above, the present applicant has found that, if there is a card that any one may readily hold and may be extensively used for commercial transaction, this is very convenient for a consumer and a field of commercial transaction with the card may be expanded. Furthermore, the applicant has found that if the usable limit amount is set within the amount of an account of the holder, the damage of card criminal may be kept within a small amount and a risk that the card suffers may be minimized. It is therefore an object of the present invention is to provide a novel commercial settlement system with a prepaid credit card.

According to the present invention, there is provided a commercial transaction settlement system using a prepaid credit card, composed of a financial agency for providing an accounting bankbook, issuing at least one prepaid credit card for which a usable maximum amount is set within an accounting amount of the accounting bankbook or a sum of the usable maximum amounts is set within the accounting amount, automatically paying from the bankbook and settling the commercial transaction in the same manner as a credit card by the transaction using the prepaid credit card, and displaying the settlement record of the commercial transaction on the bankbook, and a goods/service provider for being paid from the bankbook of a holder of the prepaid credit card to thereby settle the commercial transaction using the prepaid credit card.

According to another aspect of the invention, there is provided a commercial transaction settlement system using a prepaid credit card wherein a card is issued while entrusting a bankbook provided by a financial agency, the credit card is constituted by at least one prepaid credit card for which a usable maximum amount is set within an accounting amount of the accounting bankbook or a sum of the usable maximum amounts is set within the accounting amount, automatically paying from the bankbook and settling the commercial transaction in the same manner as a credit card are performed by the transaction using the prepaid credit card with a goods/service provider, and the settlement record of the commercial transaction on the bankbook is displayed by the financial agency.

According to still another aspect of the invention, there is provided a commercial transaction settlement system using a prepaid credit card wherein a financial agency provides an accounting bankbook, issues at least one prepaid credit card for which a usable maximum amount is set within an accounting amount of the accounting bankbook or a sum of the usable maximum amounts is set within the accounting amount, automatically pays from the bankbook and settles the commercial transaction in the same manner as a credit card by the transaction using the prepaid credit card, and displays the settlement record of the commercial transaction on the bankbook.

According to still another aspect of the invention, there is provided a commercial transaction settlement system using a prepaid credit card wherein when the commercial transaction is conducted by means of a at least one prepaid credit card for which a usable maximum amount is set within an accounting amount of an accounting bankbook provided by a financial agency or a sum of the usable maximum amounts is set within the accounting amount, a goods/service provider is paid from the bankbook provided by the financial agency, and the settlement record of the commercial transaction is displayed on the bankbook by the financial agency.

According to still another aspect of the invention, there is provided a commercial transaction settlement system using a prepaid credit card, comprising an information processing means for automatically pays from a bankbook and settles the commercial transaction in the same manner as a credit card by the transaction using the prepaid credit card, and displays the settlement record of the commercial transaction on the bankbook, when the commercial transaction is conducted by means of a at least one prepaid credit card for which a usable maximum amount is set within an accounting amount of an accounting bankbook or a sum of the usable maximum amounts is set within the accounting amount, and an information processing means for paying from the bankbook of a holder of the prepaid credit card to thereby settle the commercial transaction using the prepaid credit card.

The present invention relates to a commercial transaction settlement system using a prepaid credit card, according to any one of the preceding aspects, wherein the prepaid credit card is adapted so that a usable maximum amount may be selected within the range of 5,000 dollars or a plurality of usable maximum amounts are set in the range of 5,000 so that the usable maximum amounts may be selected from the plurality of usable maximum amounts.

The present invention relates to a commercial transaction settlement system using a prepaid credit card, according to any one of the preceding aspects, wherein the prepaid credit card is issued as a set with the bankbook by saving money in the financial agency or the prepaid credit card is issued providing that the bankbook is shown to the financial agency.

The present invention relates to a commercial transaction settlement system using a prepaid credit card, according to any one of the preceding aspects, wherein the usable maximum amount of the prepaid credit card is automatically increased by saving money in the bankbook, another prepaid credit card whose usable maximum amount is increased is issued by showing the bankbook whose accounting amount is increased by saving money, or another prepaid type credit card corresponding to the increased accounting amount is issued.

### MODE FOR EMBODYING THE INVENTION

A preferred mode for embodying the invention (how to embody the invention) will now be described briefly together with effects thereof.

At least one prepaid credit card for which a usable maximum amount is set within an accounting amount of an accounting bankbook provided by a financial agency or a sum of the usable maximum amounts is set within the accounting amount is issued.

Automatically paying from this bankbook and settling the commercial transaction in the same manner as a credit card are performed by the transaction using this prepaid credit card with a goods/service provider, and the settlement record of the commercial transaction is displayed on this bankbook.

More specifically, the commercial transaction using this prepaid credit card is conducted whereby the payment settlement is performed from the bankbook of a prepaid credit card holder by an information processing means of a goods/service provider. In response to this process, an information processing means of the financial agency automatically pays from the bankbook in the same manner as a credit card, settles the transaction and display the settlement record of the commercial transaction on the bankbook.

The usable maximum amount is set within the available accounting amount whereby the payment amount for the commercial transaction is guaranteed by the available accounting amount of the accounting bankbook. Accordingly, it is unnecessary to conduct admittance examination that is to be conducted when a credit card is to be issued. If a person holds an accounting bankbook having an available accounting amount, the prepaid credit card for which the usable maximum amount is set within the available accounting amount may be issued to any one.

Accordingly, a person who could not hold any credit card may easily hold this prepaid credit card. This prepaid credit card may be applied extensively to a variety of commercial transactions in the same manner as the conventional credit card.

Therefore, a person who could not hold his credit card and could not utilize the transaction that absolutely needs his credit card as in internet shopping may conduct the transaction by utilizing the prepaid credit card. Accordingly, the financial level of persons may be further expanded for the commercial transaction by the cards.

The usable maximum amount of this prepaid credit card is set within the accounting amount of the bankbook whereby it is possible to suppress the damage amount within the accounting amount of the bankbook at the worst even if the prepaid credit card is stolen or copied or the card number is stolen as in the conventional credit card. The risk of using this prepaid credit card continuously is low in comparison with the conventional credit card.

Furthermore, it is possible to issue ten prepaid credit cards whose usable maximum amount is set at 100 dollars. If one or two cards out of tens are carried on, it is possible to extremely suppress the damage even if the prepaid credit card is lost to thereby further reduce the risk.

Also, when the commercial transaction is conducted by this prepaid credit card, since the usable maximum amount of the commercial transaction is set within the accounting amount, there is absolutely no fear that the settlement is impossible due to the overspending and the amount for expense is paid simultaneously automatically from the accounting bankbook in the same manner as the credit card. Then, the settlement record of the commercial transaction is displayed on this accounting bankbook. If the holder would like to confirm the current expense, he can soon confirm the expense.

Also, the usable maximum amount is set so that there is no fear that the usable maximum amount is changed like a debit card. The amount is suppressed within a small amount whereby it is possible to positively prevent the excessive expense in advance.

Recently, there are many problems that a wife who is entrusted for controlling the living cost would too much expend money, the expense reaches a large amount of debt without her husband's authorization. For instance, by utilizing the system according to the present invention, if a prepaid credit card whose usable maximum amount is set at 1,000 dollars depending upon the bankbook held by the husband is issued and the prepaid credit card is given to his wife for the living cost for one month, it is possible to absolutely prevent his wife from expend money too much and the settlement record of the commercial transaction is displayed on the bankbook. It is therefore possible for the husband to manage the living cost while checking the settlement record.

Accordingly, it is possible to provide a novel commercial transaction settlement system with a prepaid credit card, which is excellent in practical use and suitable for the current society situation.

Also, if the prepaid credit card is adapted so that a usable maximum amount may be selected within the range of 5,000 dollars or a plurality of usable maximum amounts are set in the range of 5,000 so that the usable maximum amounts may be selected from the plurality of usable maximum amounts. Thus, it is possible to selectively set the suitable usable maximum amount for individuals within the range of 5,000 dollars and it is possible to suppress the damage amount within 5,000 dollars at the worst even if the prepaid credit card is stolen or copied or the card number is stolen. The risk of using this prepaid credit card is low in comparison with the conventional credit card.

### DESCRIPTION OF THE PREFERRED EMBODIMENTS

According to an embodiment of the present invention, a single or a plurality of prepaid credit cards each of which the usable maximum amount is set within an accounting amount of an accounting bankbook provided by a financial agency or for which the sum of the usable maximum amount is set within the accounting amount are issued. The commercial transaction is done by using this prepaid credit card whereby the automatic payment is settled from the accounting bankbook in a manner like credit card settlement. The settlement record for the commercial settlement is displayed on the accounting bankbook.

More specifically, the above-described prepaid credit card is adapted so as to be a card that is tied up with a credit card company whereby the card may be used for a variety of commercial transaction such as retail shops, internet or mail order sales in the same manner as the conventional credit card. Namely, a prepaid card that may be used for the commercial transaction in the same manner as the conventional credit card in conventional affiliated shops (goods and service providers) of the credit card company is issued.

Incidentally, when the user performs the commercial transaction by using this prepaid credit card in the same manner as the conventional credit card, the credit company takes its charge from the used amount that the user is to pay every time. The amount from which this charge is subtracted is to be paid to the retail shop or mail order company.

Also, the agency who issues this prepaid credit card and the bankbook is likely to seek its charge to the consumer (user who uses the prepaid credit card).

Accordingly, in the case where the above-described usable maximum amount of the prepaid credit card is desired to be the same amount as that of the available accounting amount, it would be necessary to pay at least the charge, to be paid to the agency who issues the card and the bankbook, to the accounting bankbook in addition to the available amount of the accounting bankbook. Also, in the case where the amount corresponding to this charge is not to be paid, it would be reasonable that the amount obtained by subtracting this charge from the available accounting amount would become the usable maximum amount.

According to this embodiment, the usable maximum amount is set within the available accounting amount of the accounting bankbook whereby the payment amount for the commercial transaction is guaranteed by the available accounting amount of the accounting bankbook. Accordingly, it is unnecessary to conduct admittance examination that is to be conducted when a credit card is to be issued. If a person holds an accounting bankbook having an available accounting amount, the prepaid credit card for which the usable maximum amount is set within the available accounting amount may be issued to any one.

Accordingly, a person who could not hold any credit card may easily hold this prepaid credit card. Therefore, a person who could not hold his credit card and could not utilize the transaction that absolutely needs his credit card as in internet shopping may conduct the transaction by utilizing the prepaid credit card.

Also, the usable maximum amount of this prepaid credit card is set at 5,000 dollars whatsoever the available amount of the accounting bankbook is high.

The usable maximum amount is thus set within 5,000 dollars whereby it is possible to suppress the damage amount within 5,000 dollars at the worst even if the prepaid credit card is stolen or copied or the card number is stolen. The risk of using this prepaid credit card is low in comparison with the conventional credit card. Also, when the prepaid credit card is stolen or missed and so on, the notice for that reason is submitted so that such a service for stopping the use of this prepaid credit card may be conducted.

Also, the usable maximum amount of this prepaid credit card may be selected at any amount within 5,000 dollars. Otherwise, the usable maximum amount may be set at a variety of kinds such as, for example, 300 dollars, 500 dollars, 1,000 dollars, 3,000 dollars, 5,000 dollars or the like in the range of 5,000 dollars or less and may be selected from a variety of the usable maximum amounts as desired.

If the usable maximum amount may be thus selected, it is possible to set a suitable limit amount for an individual. This is therefore extremely practical.

Also, the card to be issued may be only a single card whose usable maximum amount is set within the accounting amount. Alternatively, it is possible to issue a plurality of cards which have a set amount obtained by dividing equally the usable maximum amount, i.e., that reaches the sum of the usable maximum amount.

Also, after the issuance of this prepaid credit card, the money may be paid from the accounting bankbook as usual. Alternatively, the money may be paid only by the transaction using the prepaid credit card.

Also, in this embodiment, when the commercial transaction is conducted with this prepaid credit card, the instantaneous settlement is performed and the settlement record of the commercial transaction may be displayed on the accounting bankbook.

More specifically, in this embodiment, information processing units (computers) are provided in the financial agency and the affiliates (goods and service providers), respectively. When the commercial transaction with the prepaid credit card is completed, the transaction amount is charged to the information processing units, provided in the financial agency of the card issuance, through an on-line (net work) from the information processing unit (computer) provided in the affiliates. The information processing unit of the financial agency pays the money to the affiliates regarding the transaction amount as the payment from the card user's accounting bankbook in response to this charge. The settlement record of this commercial transaction is displayed on the accounting bankbook, and simultaneously, is recorded on the card.

Accordingly, since the usable maximum amount of the commercial transaction with this prepaid credit card is set within the accounting amount, there is absolutely no fear that the settlement is impossible due to the overspending and the amount for expense is paid simultaneously automatically from the accounting bankbook in the same manner as the credit card. Then, the settlement record of the commercial transaction is displayed on this accounting bankbook.

Also, this prepaid credit card may have a system in which it is issued with the above-described accounting bankbook as a set by saving the money or alternatively a prepaid credit card may be issued providing an accounting bankbook. In anyway, since the accounting bankbook is handled, this is handled by a financial agency such as a bank.

Also, in the case where the system is adapted in which the prepaid credit card and the accounting bankbook are issued together as a set, for instance, a transaction identification number of the prepaid credit card is determined in advance and the accounting bankbook is judged only by the bankbook number. Therefore, it is possible to simplify the clerical procedure.

Also, this prepaid credit card has a system in which the identification as to whether the holder of the card is the eligible person or not is performed in accordance with the identification number or execution (sign) in the same manner as the conventional credit card or the debit card upon transaction. Incidentally, it is possible to adapt a system in which the identification by the identification number or the execution may be dispensed with like a prepaid card such as a telephone card or a highway card. However, it is desirable to adapt the system in which the identification is to be done as in the present embodiment because the card is hardly illegally used when the card is lost or stolen so that the damage hardly occurs.

Also, according to this embodiment, even if the accounting amount is zero in the bankbook, it is possible to continuously use the prepaid credit card by saving money again in this accounting bankbook.

Also, in this case, in the case where more money is saved than the set limit amount of the prepaid credit card which is set in advance, it is possible to selectively set the amount again so that the set limit amount of the prepaid credit card may be raised.

In this case, for instance, it is possible to adapt a system in which the usable maximum limit amount of the above-described prepaid credit card is automatically raised by saving money in the bankbook or alternatively, another prepaid credit card whose usable maximum amount is raised may be issued by showing the bankbook whose account amount has been increased by saving money or another prepaid credit card corresponding the increased accounting amount may be issued.

Incidentally, according to the present invention, the currency unit is set to Dollar but may be used in terms of Yen or Fran or any other currency units.

A least one prepad credit card for which a usable maximum amount is set within an accounting amount of the accounting bankbook or a sum of the usable maximum amounts is set within the accounting amount is issued. Accordingly, the payment amount for the commercial transaction is guaranteed by the available accounting amount of the accounting bankbook. Accordingly, it is unnecessary to conduct admittance examination that is to be conducted when a credit card is to be issued. If a person holds an accounting bankbook having an available accounting amount, the prepaid credit card for which the usable maximum amount is set within the available accounting amount may be issued to any one.

Accordingly, a person who could not hold any credit card may easily hold this prepaid credit card. Therefore, a person who could not hold his credit card and could not utilize the transaction that absolutely needs his credit card as in internet shopping may conduct the transaction by utilizing the prepaid credit card. Accordingly, the financial level of persons may be further expanded for the commercial transaction by the cards. Accordingly, it is possible to provide a novel commercial transaction settlement system with a prepaid credit card, which is excellent in practical use.

The usable maximum amount of this prepaid credit card is set within the available accounting amount of the accounting bankbook whereby it is possible to suppress the damage amount due to a continuous use of the card even if the prepaid credit card is stolen or copied or the card number is stolen as in the conventional credit card. The risk of using this prepaid credit card is very low in comparison with the conventional credit card. Also, when the commercial transaction is conducted by this prepaid credit card, since the usable maximum amount is set within the accounting amount, there is absolutely no fear that the settlement is impossible due to the overspending. Also, the usable maximum amount is set so that there is no fear that the usable maximum amount is changed like a debit card. The amount is suppressed within a small amount whereby it is possible to positively prevent the excessive expense in advance. Also, the amount for expense is paid simultaneously automatically from the accounting bankbook in the same manner as the credit card. Then, the settlement record of the commercial transaction is displayed on this accounting bankbook. If the holder would like to confirm the current expense, he can soon confirm the expense. Accordingly, it is possible to provide a novel commercial transaction settlement system with a prepaid credit card, which is excellent in practical use.

Also, according to the present invention, the automatic payment settlement from the bankbook of the prepaid credit card holder and the display of the settlement record of the commercial transaction on the bankbook are extremely smoothly and positively performed by the information processing means whereby it is possible to provide an excellent commercial settlement system with a prepaid credit card.

Also, according to the present invention, it is possible to selectively set the suitable usable maximum amount for individuals within the range of 5,000 dollars and it is possible to suppress the damage amount within 5,000 dollars even if the prepaid credit card is stolen or copied or the card number is stolen to thereby further reduce the risk of use of this prepaid credit card. It is possible to provide an extremely excellent commercial settlement system with a prepaid credit card in practical use.

Also, according to the invention, it is possible to easily and positively issue the prepaid credit card and the bankbook without necessity of the examination in advance whereby it is possible to provide an extremely excellent commercial settlement system with a prepaid credit card.

Also, according to the invention, it is possible to continuously use the prepaid credit card by again saving money even if the accounting amount is zero whereby it is possible to provide a more excellent commercial settlement system with a prepaid credit card.

What is claimed is:

1. A commercial transaction settlement system using a prepaid credit card, composed of a financial agency for providing an accounting bankbook, issuing at least one prepaid credit card for which a usable maximum amount is set within an accounting amount of said accounting bankbook or a sum of the usable maximum amounts is set within the accounting amount, automatically paying from said bankbook and settling the commercial transaction in the same manner as a credit card by the transaction using said prepaid credit card, and displaying the settlement record of the commercial transaction on said bankbook, and a goods/service provider for being paid from said bankbook of a holder of said prepaid credit card to thereby settle the commercial transaction using said prepaid credit card.

2. A commercial transaction settlement system using a prepaid credit card wherein a card is issued while entrusting a bankbook provided by a financial agency, said credit card is constituted by at least one prepaid credit card for which a usable maximum amount is set within an accounting amount of said accounting bankbook or a sum of the usable maximum amounts is set within the accounting amount, automatically paying from said bankbook and settling the commercial transaction in the same manner as a credit card are performed by the transaction using said prepaid credit card with a goods/service provider, and the settlement record of the commercial transaction on said bankbook is displayed by said financial agency.

3. A commercial transaction settlement system using a prepaid credit card wherein a financial agency provides an accounting bankbook, issues at least one prepaid credit card for which a usable maximum amount is set within an accounting amount of said accounting bankbook or a sum of the usable maximum amounts is set within the accounting amount, automatically pays from said bankbook and settles the commercial transaction in the same manner as a credit card by the transaction using said prepaid credit card, and displays the settlement record of the commercial transaction on said bankbook.

4. A commercial transaction settlement system using a prepaid credit card wherein when the commercial transaction is conducted by means of a at least one prepaid credit card for which a usable maximum amount is set within an accounting amount of an accounting bankbook provided by a financial agency or a sum of the usable maximum amounts is set within the accounting amount, a goods/service provider is paid from said bankbook provided by said financial agency, and the settlement record of the commercial transaction is displayed on said bankbook by said financial agency.

5. A commercial transaction settlement system using a prepaid credit card, comprising an information processing means for automatically pays from a bankbook and settles the commercial transaction in the same manner as a credit card by the transaction using said prepaid credit card, and displays the settlement record of the commercial transaction on said bankbook, when the commercial transaction is conducted by means of a at least one prepaid credit card for which a usable maximum amount is set within an accounting amount of an accounting bankbook or a sum of the usable maximum amounts is set within the accounting amount, and an information processing means for paying from said bankbook of a holder of said prepaid credit card to thereby settle the commercial transaction using said prepaid credit card.

6. The commercial transaction settlement system using a prepaid credit card, according to any one of claims 1 to 5, wherein said prepaid credit card is adapted so that a usable maximum amount may be selected within the range of 5,000 dollars or a plurality of usable maximum amounts are set in the range of 5,000 so that the usable maximum amounts may be selected from said plurality of usable maximum amounts.

7. The commercial transaction settlement system using a prepaid credit card, according to any one of claims 1 to 5, wherein said prepaid credit card is issued as a set with said bankbook by saving money in the financial agency or said prepaid credit card is issued providing that said bankbook is shown to said financial agency.

8. The commercial transaction settlement system using a prepaid credit card, according to claim 6, wherein said prepaid credit card is issued as a set with said bankbook by saving money in the financial agency or said prepaid credit card is issued providing that said bankbook is shown to said financial agency.

9. The commercial transaction settlement system using a prepaid credit card, according to any one of claims 1 to 5, wherein the usable maximum amount of said prepaid credit card is automatically increased by saving money in said bankbook, another prepaid credit card whose usable maximum amount is increased is issued by showing the bankbook whose accounting amount is increased by saving money, or another prepaid type credit card corresponding to the increased accounting amount is issued.

10. The commercial transaction settlement system using a prepaid credit card, according to claim 6, wherein the usable maximum amount of said prepaid credit card is automatically increased by saving money in said bankbook, another prepaid credit card whose usable maximum amount is increased is issued by showing the bankbook whose accounting amount is increased by saving money, or another prepaid type credit card corresponding to the increased accounting amount is issued.

11. The commercial transaction settlement system using a prepaid credit card, according to claim 7, wherein the usable maximum amount of said prepaid credit card is automatically increased by saving money in said bankbook, another prepaid credit card whose usable maximum amount is increased is issued by showing the bankbook whose accounting amount is increased by saving money, or another prepaid type credit card corresponding to the increased accounting amount is issued.

12. The commercial transaction settlement system using a prepaid credit card, according to claim 8, wherein the usable maximum amount of said prepaid credit card is automatically increased by saving money in said bankbook, another prepaid credit card whose usable maximum amount is increased is issued by showing the bankbook whose accounting amount is increased by saving money, or another prepaid type credit card corresponding to the increased accounting amount is issued.
